(19) United States
(12) Patent Application Publication
(10) Pub. No.: US 2025/0141742 A1
(43) Pub. Date: May 1, 2025

(54) ENHANCED VIRTUAL NETWORKING WITH CLOUD EDGE PROVIDERS

(71) Applicant: Level 3 Communications, LLC, Broomfield, CO (US)

(72) Inventors: William POWER, Boulder, CO (US); Vincent TAISIPIC, Denver, CO (US)

(73) Assignee: Level 3 Communications, LLC, Broomfield, CO (US)

(21) Appl. No.: 18/522,093

(22) Filed: Nov. 28, 2023

Related U.S. Application Data
(60) Provisional application No. 63/594,697, filed on Oct. 31, 2023.

(51) Int. Cl. H04L 41/082; H04L 12/14; H04L 43/0882

(52) U.S. Cl. CPC H04L 41/082; H04L 12/1442; H04L 43/0882

(57) ABSTRACT

This disclosure describes systems, methods, and devices related to managing network capacity using cloud edge providers. A method may include identifying, by an edge device of a network, a request for network capacity received via an application programming interface (API), from a user of the network; identifying offers received via the API by cloud edge providers; determining that the network capacity is available at at least one of the cloud edge providers based on the offers; deploying an edge server at the at least one of the cloud edge providers based on the network capacity being available at the at least one of the cloud edge providers; and directing traffic between the user and the edge server based on the deployment.

### CROSS-REFERENCE TO RELATED APPLICATIONS

This application is related to and claims priority under 35 U.S.C. § 119 (e) from U.S. Patent Application No. 63/594,697, filed Oct. 31, 2023, titled “ENHANCED VIRTUAL NETWORKING WITH CLOUD EDGE PROVIDERS,” the entire content of which is incorporated herein by reference for all purposes.

### TECHNICAL FIELD

Embodiments of the present invention generally relate to devices, systems, and methods for enhanced virtual networking with cloud edge providers.

### BACKGROUND

Content providers are consolidating network providers, so the network providers need to expand their capacity to manage traffic for the content providers. Significant capacity increases to networks providing network traffic can be expensive.

### SUMMARY

A method of managing network capacity using cloud edge providers may include: identifying, by at least one processor of an edge device of a network, a request for network capacity received via an application programming interface (API), from a user of the network; identifying, by the at least one processor, offers received via the API by cloud edge providers; determining, by the at least one processor, that the network capacity is available at at least one of the cloud edge providers based on the offers; deploying, by the at least one processor, an edge server at the at least one of the cloud edge providers based on the network capacity being available at the at least one of the cloud edge providers; and directing, by the at least one processor, traffic between the user and the edge server based on the deployment.

A device for managing network capacity using cloud edge providers, the device comprising memory coupled to at least one processor of an edge device of a network, wherein the at least one processor is configured to: identify a request for network capacity received via an application programming interface (API), from a user of the network; identify offers received via the API by cloud edge providers; determine that the network capacity is available at at least one of the cloud edge providers based on the offers; deploy an edge server at the at least one of the cloud edge providers based on the network capacity being available at the at least one of the cloud edge providers; and direct traffic between the user and the edge server based on the deployment.

A system for managing network capacity using cloud edge providers, the system comprising: an edge device of a network, the edge device comprising an application programming interface (API), the edge device configured to: identify a request for network capacity received via the API, from a user of the network; identify offers received via the API by cloud edge providers; determine that the network capacity is available at at least one of the cloud edge providers based on the offers; deploy an edge server at the at least one of the cloud edge providers based on the network capacity being available at the at least one of the cloud edge providers; and direct traffic between the user and the edge server based on the deployment.

### BRIEF DESCRIPTION OF THE DRAWINGS

FIG. 1 illustrates an system using an cloud edge broker to provide virtual network capacity in accordance with one embodiment.

FIG. 2 illustrates an example process of using the cloud edge broker of FIG. 1 to provide virtual network capacity in accordance with one embodiment.

FIG. 3 illustrates an example process of using the cloud edge broker of FIG. 1 to provide virtual network capacity in accordance with one embodiment.

FIG. 4 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Aspects of the present disclosure involve devices, systems, methods, and the like, for enhanced virtual networking with cloud edge providers.

As content providers consolidate vendors for their delivery networks, the delivery network vendors may need to increase their capacity to handle the volume of traffic of the content providers. For example, in content delivery networks (CDNs), if a content provider reduces their CDN venders from seven to two vendors, the two CDN vendors would need to handle the traffic that seven vendors previously handled. Increasing network capacity can be expensive. For example, to add 50 terabytes of network capacity may require investing $20 million.

Virtual networks, such as virtual CDNs (vCDNs), allow network vendors to expand capacity by running the vendors' CDN software on servers (e.g., edge computing servers) not dedicated to a respective vendor's CDN. By using such cloud vendors, a network vendor can increase its available capacity without needing to increase their own network infrastructure.

However, cloud vendors for edge computing servers may use their own user interfaces and application programming interfaces (APIs) with their own configurations to access the cloud edge servers.

In one or more embodiments, one or more cloud edge brokers of a network vendor may connect users of the network vendor's network to cloud edge providers (e.g., third-party providers) to provide network capacity to the users in addition to the network capacity of the network vendor's network (e.g., communications network). By using a single interface and a single API, the one or more cloud edge brokers may provide a single endpoint to connect the users and the cloud edge providers, matching offers from the cloud edge providers with requests from users for additional network capacity. For example, the cloud edge providers may submit offers to the API of the one or more cloud edge brokers, and the users of the network vendor's network may submit requests for additional network capacity to the API of the one or more cloud edge brokers. The offers may include the amount of capacity at a respective cloud edge provider, the cloud edge provider capability (e.g., content delivery, gaming, etc.), the server location and autonomous system number (ASN), the duration of the capacity and capability, and the price of the capacity and duration. The requests from the users of the network vendor's network may include a requested network capacity, capability, server location and ASN, duration of use, and price. The one or more cloud edge brokers may identify available capacity that meets the requested capacity at a price that the user has requested and that the cloud edge provider has offered, and when the offer meets the requested criteria, the one or more cloud edge brokers may divert traffic from the vendor's network to the one or more cloud edge providers' edge networks under the agreed criterion. In this manner, the users of the network vendor do not need to use the different respective interfaces and APIs of the cloud edge providers to seek additional network capacity, and the offers received from the cloud edge providers may result in a better price for the users than they might otherwise receive if they negotiated individually with the cloud edge providers.

In one or more embodiments, the one or more cloud edge brokers may poll the cloud edge providers for their available capacity and capability. The cloud edge providers may submit offers to the API of the one or more cloud edge brokers, which may compare the demand of the users of the vendor network to offers. When the demand of the users is met by an offer of the cloud edge providers, the one or more cloud edge brokers may reserve resources on the cloud edge provider that submitted the offer, may deploy an edge application on the cloud edge provider, and may monitor performance of the traffic of the users whose traffic is sent to the edge application on the cloud edge provider. To meet the capacity demands of a user, the one or more cloud edge brokers may use capacity of multiple cloud edge providers based on their multiple offers (e.g., deploying edge applications on the multiple cloud edge providers). The one or more cloud edge brokers may allocate resources from an existing pool of resources on the vendor network (e.g., when the vendor network has available capacity), or may reserve additional resources on one or more cloud edge providers based on the offers.

In one or more embodiments, a single API may allow users of the vendor network to request capacity for their edge applications. The API also may allow third-party cloud edge providers to submit their offers for users of the vendor network. The one or more cloud edge brokers may continuously match user demand with available capacity in the vendor network and/or in the cloud edge providers. The cloud edge brokers may retain a certain amount of offered capacity at the cloud edge providers so that future demand from network vendor users may be satisfied (e.g., retain some available cloud capacity so that when a next user request for additional capacity is received, some cloud capacity may be available to satisfy it).

In one or more embodiments, the API may be customer-facing, providing an abstraction layer to the users of the vendor network. The API may allow the collection of cloud edge providers to act as a large homogenous pool of capacity. The API and the one or more cloud edge brokers may match user demand with network capacity at an optimized price. The API may allow the edge cloud providers to offer capacity to users of the vendor network users at a given price.

In one or more embodiments, when a network vendor user offer cannot be met by the available capacity at the network vendor and/or offering cloud edge providers, the one or more cloud edge brokers may poll the cloud edge providers for capacity at a requested price in a negotiation. The one or more cloud edge brokers may use the API to ask a requesting user for updated conditions for additional capacity (e.g., querying a user for additional cost of a cloud edge provider).

The above descriptions are for purposes of illustration and are not meant to be limiting. Numerous other examples, configurations, processes, etc., may exist, some of which are described in greater detail below. Example embodiments will now be described with reference to the accompanying figures.

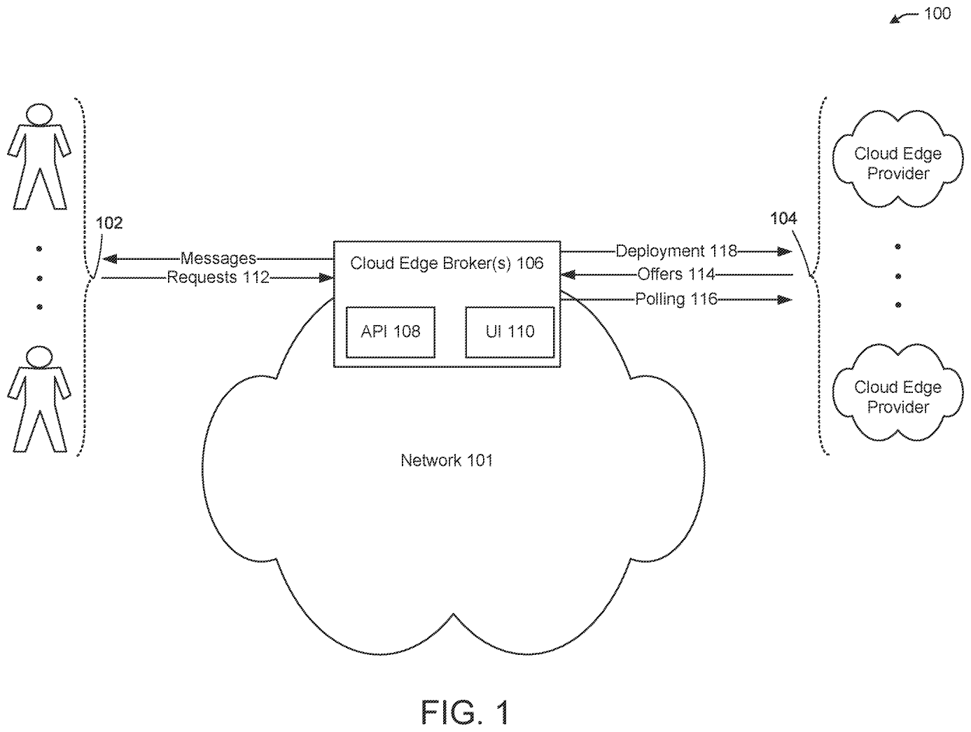

FIG. 1 illustrates an system using an cloud edge broker to provide virtual network capacity in accordance with one embodiment.

Referring to FIG. 1, the system 100 may include a network 101 that may manage traffic for users 102. When traffic demand for the users 102 exceeds a capacity provided by the network 101, the network 101 may use virtual networks provided by cloud edge providers 104 to provide the additional capacity. To facilitate the additional capacity in a convenient manner for the users 102 and the cloud edge providers 104, the network 101 may include one or more cloud edge brokers 106 for identifying additional capacity at the network 101 and/or the cloud edge providers 104 for the users 102. The one or more cloud edge brokers 106 may include an API 108 and a user interface (UI) 110 to which the users 102 may submit requests 112 for additional capacity, and to which the cloud edge providers 104 may submit offers 114 of virtual network capacity at the could edge providers' 104 networks. The one or more cloud edge brokers 106 may poll 116 the cloud edge providers 104 to provide their offers 114 (e.g., periodically and/or in response to the requests 112). When the one or more cloud edge brokers 106 identifies one or more of the offers 114 meeting the criterion of one of the requests 112, the one or more cloud edge brokers 106 may deploy 118 one or more edge applications on the cloud edge provider(s) whose offer meets the criterion of the request, allowing for the respective user to use the one or more edge applications of the cloud edge provider(s) for their capabilities. The one or more cloud edge brokers 106 may send messages 120 to the users 102 indicating the use of the edge cloud providers 104, and/or to negotiate when a request cannot be satisfied (e.g., to indicate that more cost is needed to pay for the requested additional capacity).

In one or more embodiments, by using the API 108 and the UI 110 as a single API and a single interface, respectively, the one or more cloud edge brokers 106 may provide a single endpoint to connect the users 102 and the cloud edge providers 104, matching offers 114 from the cloud edge providers 104 with requests 112 from users 102 for additional network capacity. For example, the cloud edge providers 104 may submit offers 114 to the API 108 of the one or more cloud edge brokers 106, and the users 102 of the network 101 may submit requests 112 for additional network capacity to the API 108 of the one or more cloud edge brokers 106. The offers 114 may include the amount of capacity at a respective cloud edge provider, the cloud edge provider capability (e.g., content delivery, gaming, etc.), the server location and autonomous system number (ASN), the duration of the capacity and capability, and the price of the capacity and duration. The requests 112 from the users 102 of the network 101 may include a requested network capacity, capability, server location and ASN, duration of use, and price. The one or more cloud edge brokers 106 may identify available capacity that meets the requested capacity at a price that the user has requested and that the cloud edge provider has offered, and when the offer 114 meets the requested criteria, the one or more cloud edge brokers 106 may divert traffic from the network 101 to the one or more cloud edge providers' edge networks under the agreed criterion. In this manner, the users 102 of the network 101 do not need to use the different respective interfaces and APIs of the cloud edge providers 104 to seek additional network capacity, and the offers 114 received from the cloud edge providers 104 may result in a better price for the users 102 than they might otherwise receive if they negotiated individually with the cloud edge providers 104.

In one or more embodiments, the one or more cloud edge brokers 106 may poll 116 the cloud edge providers 104 for their available capacity and capability. The cloud edge providers 104 may submit offers 114 to the API 108 of the one or more cloud edge brokers 106, which may compare the demand of the users 102 of the network 101 to offers. When the demand of the users 102 is met by an offer of the cloud edge providers 104, the one or more cloud edge brokers 106 may reserve resources on the cloud edge provider that submitted the offer, may deploy 118 an edge application on the cloud edge provider, and may monitor performance of the traffic of the users 102 whose traffic is sent to the edge application on the cloud edge provider. To meet the capacity demands of a user, the one or more cloud edge brokers 106 may use capacity of multiple cloud edge providers 104 based on their multiple offers 114 (e.g., deploying edge applications on the multiple cloud edge providers). The one or more cloud edge brokers 106 may allocate resources from an existing pool of resources on the network 101 (e.g., when the network 101 has available capacity), or may reserve additional resources on one or more cloud edge providers 104 based on the offers 114.

In one or more embodiments, a single API 108 may allow users 102 of the network 101 to request capacity for their edge applications. The API 108 also may allow third-party cloud edge providers 104 to submit their offers 114 for users 102 of the network 101. The one or more cloud edge brokers 106 may continuously match user demand with available capacity in the network 101 and/or in the cloud edge providers 104. The cloud edge brokers 106 may retain a certain amount of offered capacity at the cloud edge providers 104 so that future demand from network 101 users 102 may be satisfied (e.g., retain some available cloud capacity so that when a next user request for additional capacity is received, some cloud capacity may be available to satisfy it).

In one or more embodiments, the API 108 may be customer-facing, providing an abstraction layer to the users of the network 101. The API 108 may allow the collection of cloud edge providers 104 to act as a large homogenous pool of capacity. The API 108 and the one or more cloud edge brokers 106 may match user demand with network capacity at an optimized price. The API 108 may allow the edge cloud providers 104 to offer 114 capacity to users 102 of the network 101 users 102 at a given price.

In one or more embodiments, the network 101 may be a CDN or another type of network. For example, the network 101 may deliver content or other traffic to and from the user 102. In some embodiments, the network 101 may be a network vendor of a service such as a content delivery service (e.g., gaming, streaming video, or the like). The users 102 may watch streaming content, play games, or the like, delivered by the network 101. Traffic demand of the users 102 may increase to a capacity larger than what the network 101 may provide, such as during popular sporting events, game releases, and the like. To provide the additional capacity for the demand of the users 102, the network 101 may identify the additional capacity at the cloud edge providers 104. In this manner, the cloud edge providers 104 may be third parties with their own capacity, capabilities, and services. Instead of the users 102 separately configuring their networks and traffic to use one or more of the cloud edge providers 104, the one or more cloud edge brokers 106 may allow the users 102 of the network 101 to use resources of the cloud edge providers 104 to increase capacity of the network 101. In this manner, the users 102 may use the cloud edge providers 104 through the network 101. When the traffic provided to/from the users 102 is provided by a service that has contracted with the network 101 as a vendor, the service does not have to separately contract with the cloud edge providers, and can minimize its number of network vendors. The network 101 as a result can offer additional capacity to services used by the users 102 without needing expensive additional infrastructure, instead using additional virtual capacity provided by the cloud edge providers 104 in a manner that is simplified and convenient to both the users 102 and the cloud edge providers 104.

In one or more embodiments, the API 108 may be configured to allow communications between the one or more cloud edge brokers 106 and multiple cloud edge providers 104. Any of the cloud edge providers 104 may have their own configurations with which to deploy edge servers. Rather than the users 102 needing multiple configurations for the different cloud edge providers 104, the API 108 removes the need for the users 102 to learn the configurations of the cloud edge providers 104.

In one or more embodiments, the one or more cloud edge brokers 106 may include one or more processing devices, modules, and/or software to send and receive API calls, including the requests 112 and the offers 114, and the logic to match the offered capacity to the requested capacity.

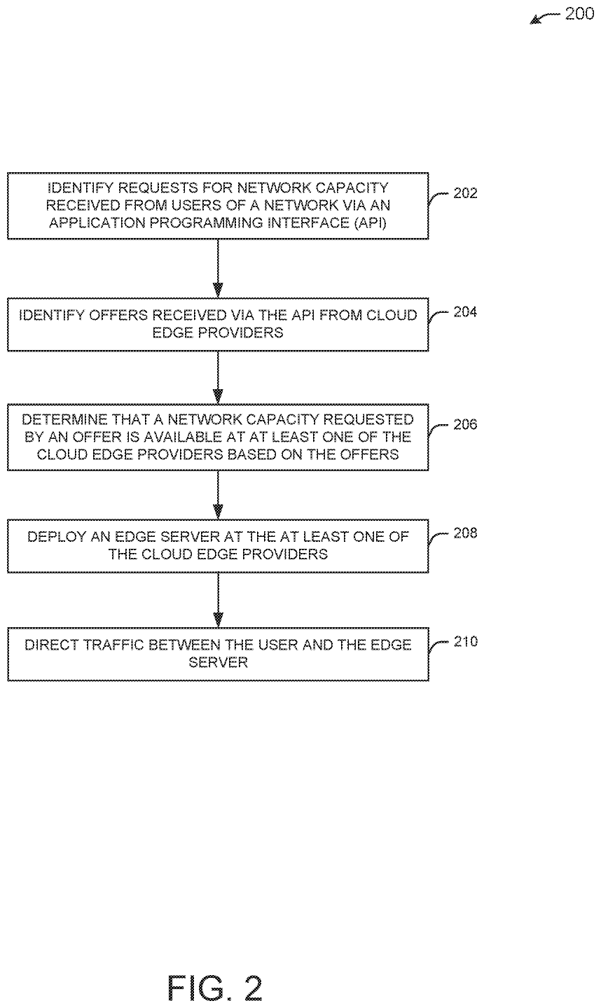

FIG. 2 illustrates an example process 200 of using the cloud edge broker 106 of FIG. 1 to provide virtual network capacity in accordance with one embodiment.

At block 202, a device (or system, e.g., the one or more cloud edge brokers 106 of FIG. 1) of a network (e.g., the network 101 of FIG. 1) may identify requests (e.g., the requests 112 of FIG. 1) received from users (e.g., the users 102 of FIG. 1) of the network. The requests may include a first indication of the network capacity, a second indication of a requested network capability, a third indication of an edge server location, a fourth indication of a duration of use of the network capacity, and a fifth indication of a price to pay for the network capacity. The requests may be received via an API (e.g., the API 108 of FIG. 1), which receives requests from multiple users of the network.

At block 204, the device may identify offers (e.g., the offers 114 of FIG. 1) received via the API from cloud edge providers (e.g., the cloud edge providers 104 of FIG. 1). Any offer may include a first indication of an offered network capacity, a second indication of an offered network capability, a third indication of an offered edge server location, a fourth indication of an offered duration of use of the offered network capacity, and a fifth indication of an offered price of the offered network capacity. The API may allow multiple cloud edge providers to provide offers to users of the network for additional network capacity.

At block 206, the device may determine that a network capacity requested by an offer is available at at least one of the cloud edge providers who submitted an offer (e.g., by comparing the requests to the offers). Multiple offers or no offers may satisfy the criterion of a request.

At block 208, the device may deploy an edge server at the at least one of the cloud edge providers. At block 210, the device may direct traffic from the requesting user to the at least one of the cloud edge providers, specifically to the deployed edge server(s). The device may monitor the traffic between the network users and the cloud edge providers on which the device deployed an edge server.

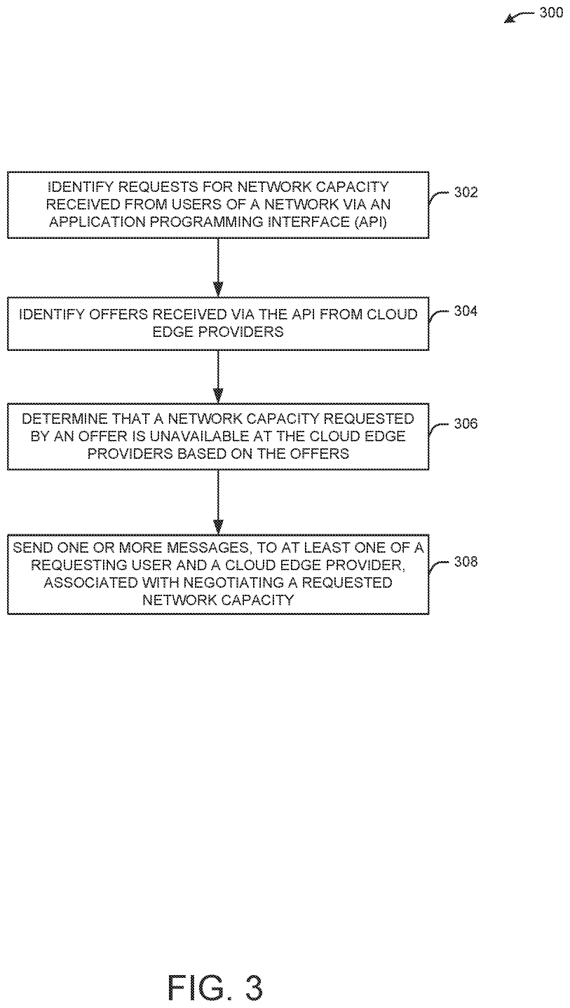

FIG. 3 illustrates an example process 300 of using the cloud edge broker 106 of FIG. 1 to provide virtual network capacity in accordance with one embodiment.

At block 302, a device (or system, e.g., the one or more cloud edge brokers 106 of FIG. 1) of a network (e.g., the network 101 of FIG. 1) may identify requests (e.g., the requests 112 of FIG. 1) received from users (e.g., the users 102 of FIG. 1) of the network. The requests may include a first indication of the network capacity, a second indication of a requested network capability, a third indication of an edge server location, a fourth indication of a duration of use of the network capacity, and a fifth indication of a price to pay for the network capacity. The requests may be received via an API (e.g., the API 108 of FIG. 1), which receives requests from multiple users of the network.

At block 304, the device may identify offers (e.g., the offers 114 of FIG. 1) received via the API from cloud edge providers (e.g., the cloud edge providers 104 of FIG. 1). Any offer may include a first indication of an offered network capacity, a second indication of an offered network capability, a third indication of an offered edge server location, a fourth indication of an offered duration of use of the offered network capacity, and a fifth indication of an offered price of the offered network capacity. The API may allow multiple cloud edge providers to provide offers to users of the network for additional network capacity.

At block 306, the device may determine that a network capacity requested by an offer is unavailable at at least one of the cloud edge providers who submitted an offer (e.g., by comparing the requests to the offers). Multiple offers or no offers may satisfy the criterion of a request.

At block 308, the device may send one or more messages (e.g., the messages 120 of FIG. 1, the polling 116 of FIG. 1) to negotiate the requested capacity, such as to ask for a different price for the requesting user to pay or for the cloud edge provider to accept. When the device finds the available capacity (e.g., block 206 of FIG. 2), the device may proceed to block 208 of FIG. 2.

It is understood that the above descriptions are for purposes of illustration and are not meant to be limiting.

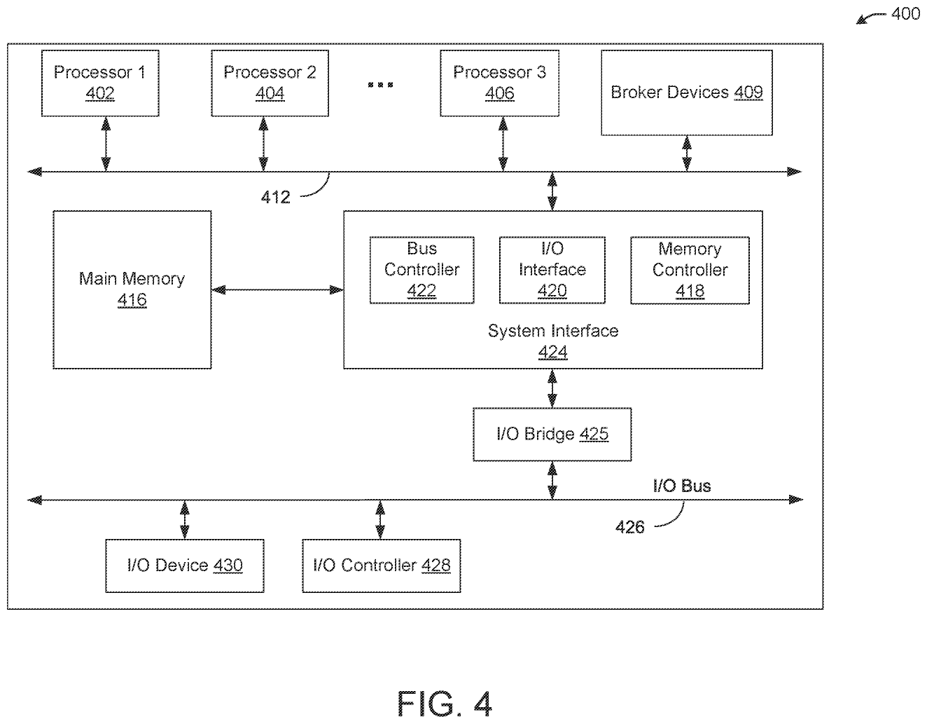

FIG. 4 is a block diagram illustrating an example of a computing device or computer system 400 which may be used in implementing the embodiments of the components of the network disclosed above. For example, the computing system 400 of FIG. 4 may represent at least a portion of the network 101, devices of the users 102 (e.g., user devices), and/or the cloud edge providers 104 of FIG. 1, and discussed above. The computer system (system) includes one or more processors 402-406 and one or more broker devices 409 (e.g., representing the one or more cloud edge broker devices 106 of FIG. 1, capable of performing any operations described with respect to FIGS. 1-3). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method of managing network capacity using cloud edge providers, the method comprising:
identifying, by at least one processor of an edge device of a network, a request for network capacity received via an application programming interface (API), from a user of the network;
identifying, by the at least one processor, offers received via the API by cloud edge providers;
determining, by the at least one processor, that the network capacity is available at at least one of the cloud edge providers based on the offers;
deploying, by the at least one processor, an edge server at the at least one of the cloud edge providers based on the network capacity being available at the at least one of the cloud edge providers; and
directing, by the at least one processor, traffic between the user and the edge server based on the deployment.

2. The method of claim 1, wherein the request comprises a first indication of the network capacity, a second indication of a requested network capability, a third indication of an edge server location, a fourth indication of a duration of use of the network capacity, and a fifth indication of a price to pay for the network capacity.

3. The method of claim 1, wherein the an offer of the offers comprises a first indication of an offered network capacity, a second indication of an offered network capability, a third indication of an offered edge server location, a fourth indication of an offered duration of use of the offered network capacity, and a fifth indication of an offered price of the offered network capacity.

4. The method of claim 1, further comprising:
determining that an offered network capability of a first offer of the offers satisfies a requested network capability of the request;
determining that an offered edge server location of the first offer satisfies a requested edge server location of the request;
determining that an offered duration of the first offer satisfies a requested duration of the network capacity; and
determining that an offered price of the first offer satisfies a requested price of the first offer,
wherein deploying the edge server at the at least one of the cloud edge providers is further based on the offered network capability satisfying the requested network capability, the offered edge server location satisfying the requested edge server location, the offered duration satisfies the requested duration, and the offered price satisfies the requested price.

5. The method of claim 1, wherein the offers received via the API comprise a first offer received from a first cloud edge provider and a second offer received from a second cloud edge provider different than the first cloud edge provider.

6. The method of claim 5, wherein a first offered network capacity of the first offer is different than a second offered network capacity of the second offer.

7. The method of claim 1, wherein determining that the network capacity is available at the at least one of the cloud edge providers further comprises determining that the network capacity is available at a first cloud edge provider and at a second cloud edge provider.

8. The method of claim 1, further comprising monitoring the traffic between the user and the edge server.

9. The method of claim 1, further comprising:
identifying a second request for second network capacity received via the API, from a second user of the network;
identifying second offers received via the API by the cloud edge providers;
determining that the second network capacity is unavailable the cloud edge providers based on the second offers; and
sending one or more messages, to at least one of the second user or the cloud edge providers, associated with negotiating the second network capacity.

10. A device for managing network capacity using cloud edge providers, the device comprising memory coupled to at least one processor of an edge device of a network, wherein the at least one processor is configured to:
identify a request for network capacity received via an application programming interface (API), from a user of the network;
identify offers received via the API by cloud edge providers;
determine that the network capacity is available at at least one of the cloud edge providers based on the offers;
deploy an edge server at the at least one of the cloud edge providers based on the network capacity being available at the at least one of the cloud edge providers; and
direct traffic between the user and the edge server based on the deployment.

11. The device of claim 10, wherein the request comprises a first indication of the network capacity, a second indication of a requested network capability, a third indication of an edge server location, a fourth indication of a duration of use of the network capacity, and a fifth indication of a price to pay for the network capacity.

12. The device of claim 10, wherein the an offer of the offers comprises a first indication of an offered network capacity, a second indication of an offered network capability, a third indication of an offered edge server location, a fourth indication of an offered duration of use of the offered network capacity, and a fifth indication of an offered price of the offered network capacity.

13. The device of claim 10, wherein the at least one processor is further configured to:
determine that an offered network capability of a first offer of the offers satisfies a requested network capability of the request;
determine that an offered edge server location of the first offer satisfies a requested edge server location of the request;
determine that an offered duration of the first offer satisfies a requested duration of the network capacity; and
determine that an offered price of the first offer satisfies a requested price of the first offer,
wherein to deploy the edge server at the at least one of the cloud edge providers is further based on the offered network capability satisfying the requested network capability, the offered edge server location satisfying the requested edge server location, the offered duration satisfies the requested duration, and the offered price satisfies the requested price.

14. The device of claim 10, wherein the offers received via the API comprise a first offer received from a first cloud edge provider and a second offer received from a second cloud edge provider different than the first cloud edge provider.

15. The device of claim 14, wherein a first offered network capacity of the first offer is different than a second offered network capacity of the second offer.

16. The device of claim 10, wherein to determine that the network capacity is available at the at least one of the cloud edge providers further comprises to determine that the network capacity is available at a first cloud edge provider and at a second cloud edge provider.

17. The device of claim 10, wherein the at least one processor is further configured to monitor the traffic between the user and the edge server.

18. The device of claim 10, wherein the at least one processor is further configured to:
identify a second request for second network capacity received via the API, from a second user of the network;
identify second offers received via the API by the cloud edge providers;
determine that the second network capacity is unavailable the cloud edge providers based on the second offers; and
send one or more messages, to at least one of the second user or the cloud edge providers, associated with negotiating the second network capacity.

19. A system for managing network capacity using cloud edge providers, the system comprising:
an edge device of a network, the edge device comprising an application programming interface (API), the edge device configured to:
identify a request for network capacity received via the API, from a user of the network;
identify offers received via the API by cloud edge providers;
determine that the network capacity is available at at least one of the cloud edge providers based on the offers;
deploy an edge server at the at least one of the cloud edge providers based on the network capacity being available at the at least one of the cloud edge providers; and
direct traffic between the user and the edge server based on the deployment.

20. The system of claim 19, wherein the request comprises a first indication of the network capacity, a second indication of a requested network capability, a third indication of an edge server location, a fourth indication of a duration of use of the network capacity, and a fifth indication of a price to pay for the network capacity.
